(19) United States
(12) Patent Application Publication
(10) Pub. No.: US 2011/0181474 A1
(43) Pub. Date: Jul. 28, 2011

(54) MINIATURE THREE-DIMENSIONAL ANTENNA

(75) Inventors: CHIH-YUNG HUANG, Dongshi Township (TW); Sy-Been Wang, Zhubei City (TW); Kuo-Chang Lo, Toufen Township (TW)

(73) Assignee: ARCADYAN TECHNOLOGY CORPORATION

(21) Appl. No.: 12/885,799

(22) Filed: Sep. 20, 2010

(30) Foreign Application Priority Data
Jan. 25, 2010 (TW) 99101954

(51) Int. Cl. H01Q 9/04

(52) U.S. Cl. 343/700 MS

(57) ABSTRACT

Provided is a miniature three-dimensional antenna. The subject matter is particularly a miniature, low-height, and three-dimensional structure single-frequency antenna. In accordance with the preferred embodiment, the antenna includes a radiation member with extended structure, and the radiation member has a first radiation plane and a non-coplanar second radiation plane. One end extended from the first radiation plane forms a radiation bent member by a bending process. Furthermore, the antenna includes a feed member and a ground member which are the structure extended from the radiation member. In particularly, the first radiation plane, the second radiation plane, the radiation bent member, the feed member, and ground member are not coplanar. The three-dimensional structure is featured to provide the low-height structure, and fortify the antenna structure. Moreover, it is easy to apply to significant number of applications through adjustment of members.

### BACKGROUND OF THE INVENTION

1. Field of the Invention

The present invention generally relates to a miniature three-dimensional antenna, more particularly to the antenna with three-dimensional structure which is easily adapted to significant number of applications with specific frequencies, and further applicable in fortifying the structure of antenna.

2. Description of Related Art

In the progress of development of the wireless communication technologies, the antenna of a wireless device is a critical component that affects the overall transmission capability of the entire device. The antenna further significantly influences the device's structural design, notably including its size.

In response to the trend of device miniaturization, various miniature antennas have been developed, especially for being more useful when paired with handheld electronic devices with various sizes. The miniature devices could be mobile phones, laptop computers or other types of wireless devices such as the access point (AP).

For example, a conventional planar inverse-F antenna (PIFA) with acceptable performance is the one which is usually and easily disposed within the inner wall of a handheld electronic device.

Reference is made to FIG. 1 showing a schematic diagram of a planar inverse-F antenna of the conventional art. The planar inverse-F antenna 10 may be disposed on a substrate 100. In the feature, the radiation body is the portion drawn in twill. The twill portion includes a radiation plane 11 for radiating electromagnetic wave, a feed line 13, a ground 17, and a short line 15 for shorting the radiation plane 11 and the ground 17.

Usually, each component of the aforementioned planar inverse-F antenna 10 may be made of conductive metal. In this case, all the radiation plane 11, the feed line 13, the ground 17 and the short line 15 are disposed upon the substrate 100 in parallel. In which, the radiation plane 11 and the feed line 13 are interconnected. A wireless communication unit (not shown) in an application system may transmit the electromagnetic wave to the antenna 10 via the feed line 13, and then radiate the wave out.

### SUMMARY OF THE INVENTION

Relative to the planar antenna of the conventional technology, a miniature three-dimensional antenna in accordance with the present invention is particularly provided. The claimed miniature three-dimensional antenna may be easily adapted to significant number of applications with specific frequencies. The bent design, more particularly, of the radiation body offers significant flexibility and applicability to significant number of types of circuits. The three-dimensional design can also further fortify the structure of antenna.

According to the preferred embodiment, the miniature three-dimensional antenna primarily includes a radiation body which is extended from the antenna body. In particular, after a bending process, the non-coplanar first radiation plane and second radiation plane are formed. The one end extended from the first radiation plane has a radiation bent member.

Furthermore, the antenna body has a feed terminal extended from the second radiation plane. This feed terminal is used for signaling at the claimed antenna. A ground terminal is also provided extended from the second radiation plane. The ground terminal adjacent to the feed terminal is used for the ground contact of the antenna.

The radiation bent member may be a one-folded member extended from the first radiation plane. In one further embodiment, multi-folded structure is also provided.

More particularly, the described first radiation plane, the second radiation plane, the radiation bent member, the feed member, and the ground terminal are non-coplanar. By which, a three-dimensional antenna is provided.

In accordance with one embodiment, the length of extension of the radiation body is about one quarter of the resonant wavelength of a desired application with a specific frequency. Under this scheme, the radiation body may include significant number of applications with some frequency bands after suitable modifications.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a structural diagram of a conventional planar inverse-F antenna;

FIG. 2 shows a schematic diagram of the components of the miniature three-dimensional antenna in accordance with the present invention;

FIG. 3 is one of the embodiments of the miniature three-dimensional antenna in accordance with invention;

FIG. 4 is the second of the embodiments of the miniature three-dimensional antenna in accordance with the present invention;

FIG. 5 is third of the embodiments of the miniature three-dimensional antenna in accordance with the present invention;

FIG. 6 shows a plan view of the miniature three-dimensional antenna of the embodiment in accordance with the present invention;

FIG. 7 shows a schematic diagram of the second embodiment of the miniature three-dimensional antenna in accordance with the present invention;

FIG. 8 depicts VSWR of an application of the miniature three-dimensional antenna in accordance with the present invention;

FIG. 9A depicts radiation characteristics of the claimed antenna on a Y-Z plane;

FIG. 9B depicts radiation characteristics of the claimed antenna on a Z-X plane;

FIG. 9C depicts radiation characteristics of the claimed antenna on an X-Y plane.

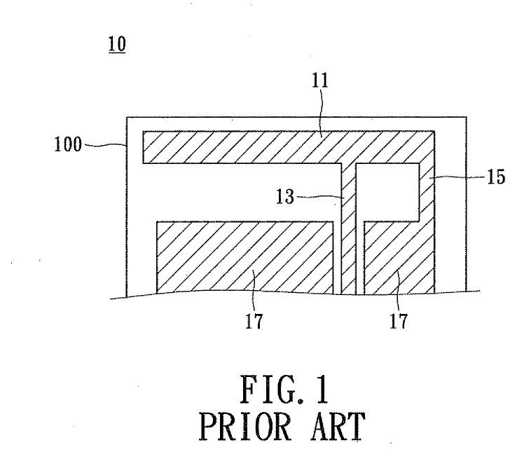

### DETAILED DESCRIPTION OF THE PREFERRED EMBODIMENTS

While the present invention will be described more fully hereinafter with reference to the accompanying drawings, in which one or more preferred embodiments of the present invention is or are shown, it is to be understood at the outset of the description which follows that persons of skill in the appropriate arts may modify the invention here described while still achieving the favorable results of the invention. Accordingly, the description which follows is to be understood as teaching disclosure directed to persons of skill in the appropriate arts, and not as limiting upon the present invention.

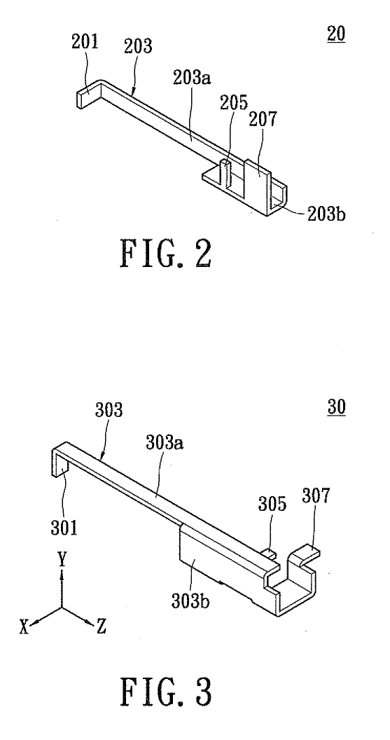

A miniature three-dimensional antenna of an embodiment in accordance with the present invention is provided. Reference is made to FIG. 2, showing a schematic diagram of the claimed antenna. The antenna body 20 has at least several components, including two electrical contacts extended from one end of the antenna body 20. One of the contacts is a signal feed terminal 205, and the other is a ground terminal 207. The longer part of the body is a radiation body 203. An extension with a predefined length of the radiation body 203 is further extended as a perpendicular portion. A radiation bent member 201 is accordingly formed.

Furthermore, the length of extension of the radiation body 203 is about one quarter of the resonant wavelength applied to an application with a specific frequency. As such, the claimed radiation body may be applicable to the radiation body of an application with a suitable frequency after a reasonable modification.

More particularly, since the radiation body 203 is under a bending process, two non-coplanar radiation planes are formed. That is a first radiation plane 203a and a second radiation plane 203b, and these two planes are nearly perpendicular to each other. The radiation bent member 201 is the extended structure from the first radiation plane 203a. In one embodiment, the radiation bent member 201 is preferably perpendicular to the first radiation plane 203a.

Furthermore, the mentioned feed terminal 205 and the ground terminal 207 may both be an extended structure of the second radiation plane 203b. More, these two terminals are the two electrical contacts that welded with a circuit (not shown) of a communication system.

The previously mentioned components, including the first radiation plane, the second radiation plane, the radiation bent member, the feed member, and the ground terminal, are not entirely coplanar. The bent structure lowers the height of the antenna to fulfill the goal of miniaturization, especially to some applications requiring thin structure. It is worth noting that the three-dimensional design can fortify the antenna other than the conventional flat design.

### Embodiments

Reference is made to FIG. 3 which schematically illustrates one of the embodiments of the miniature three-dimensional antenna in accordance with the present invention. Antenna 30 includes some non-coplanar components. The radiation body 303 is the extended structure of the body of the claimed antenna. This radiation body 303 includes the non-coplanar first radiation plane 303a and second radiation plane 303b after a bending process.

As shown in the diagram, the one end extended from the first radiation plane303 has a downward bent structure. The bent structure is the radiation bent member 301 which is one portion of the radiation body 303. Further, since the second radiation plane 303b is treated by a one-folded bending process, the electrical contacts such as the feed terminal 305 and the ground terminal 307 are formed.

In which, the feed terminal 305 is electrically coupled with the second radiation plane 303b of the radiation body 303, and also the extended portion thereto. The feed terminal 305 is a signaling terminal of the antenna 30. The ground terminal 307 is adjacent to the feed member 305. This ground member is also electrically coupled with the second radiation plane 303b of the radiation body 303, and is the extended portion thereto.

By means of the structural bending, the feed terminal 305 and the ground terminal 307 are non-coplanar. Since these two members are formed as a three-dimensional structure, it is featured to enhance the structural stability between the antenna and the circuit board. It is worth noting that the above-described first radiation plane 303a, the second radiation plane 303b, the radiation bent member 301, the feed member 305, and the ground terminal 307 are structurally non-coplanar and formed as a three-dimensional design.

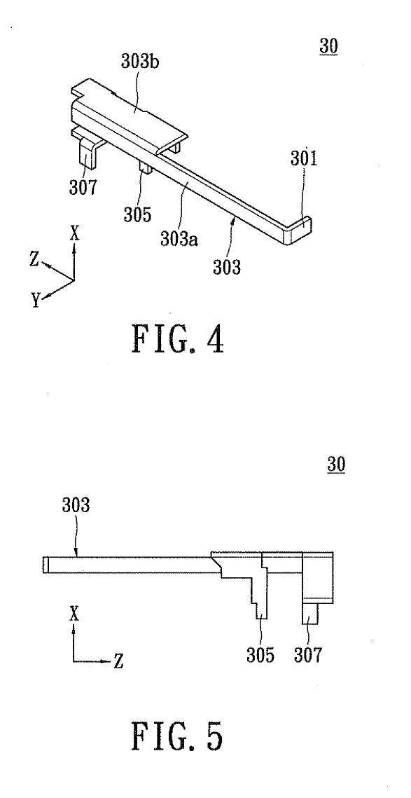

FIG. 4 shows a perspective view of the claimed miniature three-dimensional antenna depending on another viewing angle. This diagram illustrates the coupling relationship between the radiation body 303 and the radiation bent member 301. The radiation body 303 and the radiation bent member 301 are preferably perpendicular to each other. The first radiation plane 303a and the second radiation plane 303b are also preferably perpendicular to each other. The feed terminal 305 and the ground terminal 307, which are the contacts that electrically connect with other circuits, can be flexibly designed according to the various requirements.

The positions of the feed terminal 305 and the ground terminal 307 are clearly identified. Since these two contacts are not coplanar, the three-dimensional structure thereof can be fortified.

FIG. 5 further shows a lateral view of the claimed antenna. The radiation body 303 is preferably the structure extended from the antenna. The feed terminal 305 and the ground terminal 307 are the structure extended fault the body 303, and being the contacts that the antenna uses to connect with other circuits.

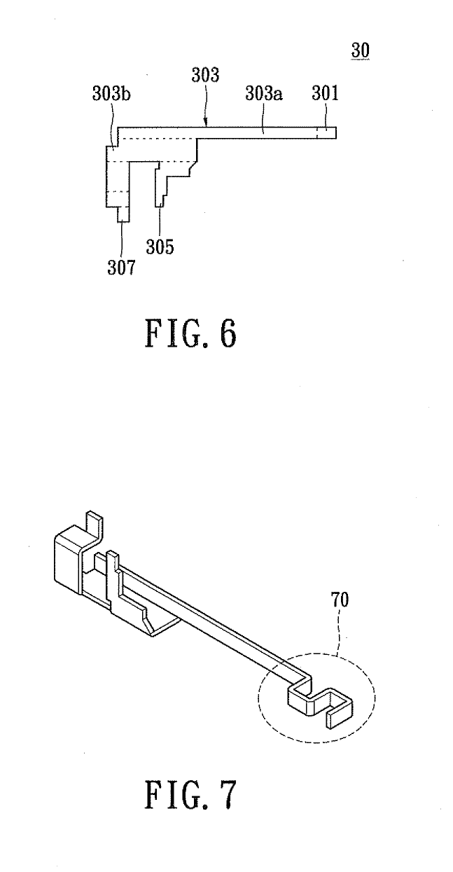

FIG. 6 shows a plan view of the miniature three-dimensional antenna in accordance with the present invention. This plan pattern illustrates the connections of the components.

The radiation body 303 is formed with two bent planes, which are the first radiation plane 303a and the second radiation plane 303b. One extended end of the first radiation plane 303a forms the radiation bent member 301. The feed member 305 and the ground terminal 307 are particularly the limbs extended from the second radiation plane 303b. The ground terminal 307 can be the form of multi-folded structure under multiple bending processes. However, the ground terminal may not be coplanar with the feed member 305. Through adjustment of the members extended from the radiation body 303, the claimed antenna may be applicable to various applications with some differing frequency bands.

The multi-folded structure is drawn by the dotted-line, which shows this folded portion is under the bending process. The bent portions form the three-dimensional antenna. Therefore, the height of the antenna can be lowered, and the design fortifies the structure.

The radiation bent member 301 is formed by performing the bending process on the extended portion of the radiation body 303. The radiation bent member 301 is then perpendicular to the first radiation plane 303a. Further reference is made to FIG. 7 showing a plurality of bent portions 70 formed by the multiple bending processes performed on the radiation bent member. The structure of those bent portions 70 particularly indicates that the claimed antenna can be flexibly designed. The various bent portions 70 may be applicable to the various applications. The three-dimensional antenna with the bent portions 70 may also reach the goal of miniaturization and structural enhancement.

The radiation bent member can be flexibly designed with one or multiple folded bent angles. Therefore, the antenna with this bent member can be made by miniaturized, low-height and three-dimensional structure. The claimed antenna may be adapted to be a single-frequency antenna. In accordance with the present invention, the antenna can be easily applied to the various systems with some suitable frequencies by some minor adjustments of members.

According to another embodiment, the area of the ground terminal may be increased to enhance the electrical properties and the effect of anti-interference.

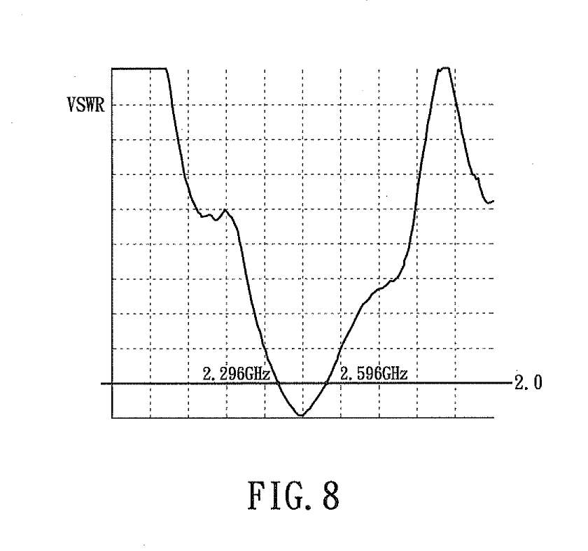

In practice, the miniature three-dimensional antenna may easily achieve various applications with their specific frequencies on account of the three-dimensional design. The reference depicted in FIG. 8 shows the achievement.

The vertical axis indicates the value of VSWR (Voltage Standing Wave Ratio of the claimed antenna. The curve illustrates the distribution of VSWR for the miniature three-dimensional antenna in accordance with the present invention. The antenna's characteristic parameters, including impedance matching, size, and height, and further collocated with the design of the feed terminal may be flexibly modified to accommodate specific applications.

Reference is made to the data of VSWR of the claimed antenna on condition that the maximum standing wave amplitude is 2.0 and the antenna's bandwidth is around 300 MHz. The measured VSWR reaching the maximum value 2.0 is between the frequency 2.29 GHz and 2.59 GHz. The wave peak is around 2.4 GHz that completely covers the wireless network at band 2.4 GHz regulated by WiFi Alliance.

Therefore, the miniature three-dimensional antenna in accordance with the present invention may applicably operate at band 2400˜2500 MHz for IEEE802.11b/g system, such as a wireless communication device.

The claimed antenna is featured that one end of its radiation body has a bent design, however, the following characteristics patterns give the evidence that this structure does not affect the overall characteristics.

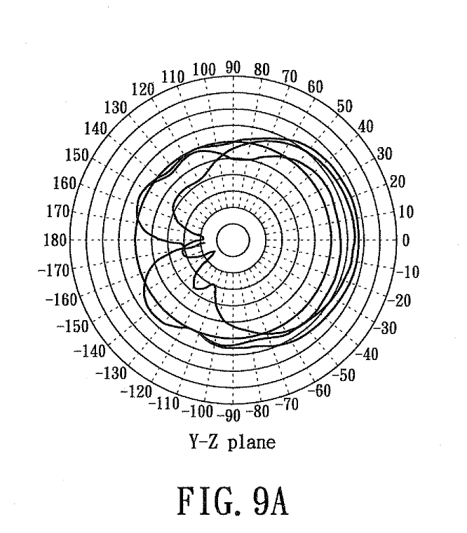

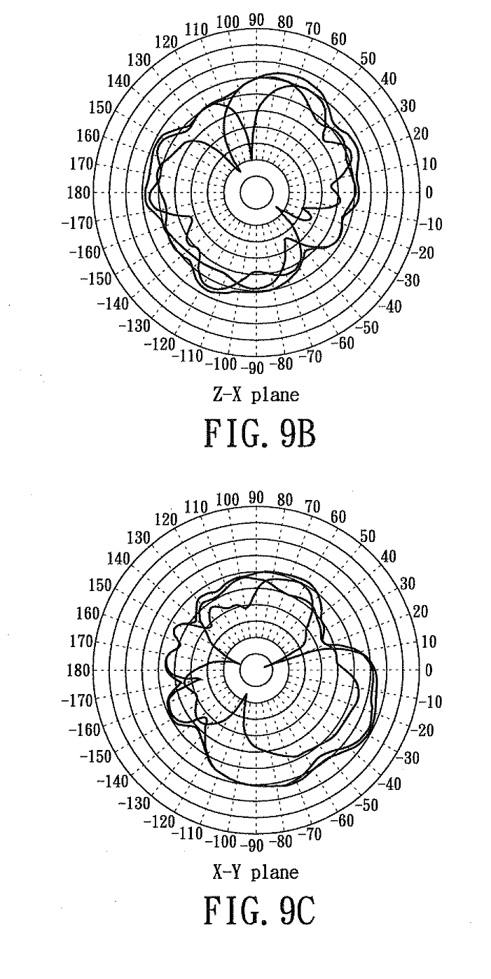

FIG. 9A shows a pattern of radiation characteristics on a Y-Z plane of the antenna in accordance with the present invention at band 2400 MHz through 2500 MHz. The axis may refer to the descriptions in FIGS. 3, 4 and 5. The shown data is the radiation gain measured on Y-Z plane when the detection signals input.

FIG. 9B shows a pattern of radiation characteristics on Z-X plane. FIG. 9C is for the pattern on X-Y plane.

From the above diagrams, the claimed miniature three-dimensional antenna may also operate at various bands along different directions, and keep good gain response without hurting overall performance.

In summation, the above description, with suitable adjustment of members, the miniaturized, low-height, and three-dimensional antenna in accordance with the present invention can easily be adapted to significant number of applications within the corresponding bands. The featured bent design and the three-dimensional structure, different form the conventional space-occupied planar inverse-F antenna, may effectively accomplish miniaturization and be applicable to significant number of applications.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A miniature three-dimensional antenna used for receiving and transmitting signals, comprising:
a radiation body extended from the miniature three-dimensional antenna, including non-coplanar a first radiation plane and a second radiation plane after a bending process;
a radiation bent member being bent structure extended from the first radiation plane;
a feed member electrically coupled with the second radiation plane and being extended from the radiation body, wherein the feed member is used for transmitting signals for the miniature three-dimensional antenna; and
a ground member adjacent to the feed member and being extended from the radiation body, and electrically coupled with the second radiation plane, wherein the contact of the ground member and the contact of the feed member are non-coplanar;
wherein, the first radiation plane, the second radiation plane, the radiation bent member, the feed member, and the ground member are structurally non-coplanar.

2. The antenna of claim 1, wherein the radiation bent member is perpendicular to the first radiation plane.

3. The antenna of claim 2, wherein the radiation bent member includes a plurality of bent portions.

4. The antenna of claim 1, wherein length of extension of the radiation body is about one quarter of a resonant wavelength of an application frequency.

5. The antenna of claim 1, wherein the first radiation plane and the second radiation plane are nearly perpendicular to each other.

6. A miniature three-dimensional antenna used for receiving and transmitting signals, comprising:
(a) a radiation body being extension of the miniature three-dimensional antenna, comprising:
(i) a first radiation plane;
(ii) a second radiation plane coupled with the first radiation plane, and which are not coplanar;
(b) a feed member electrically connected with the second radiation plane, and not coplanar to the second radiation plane after a bending process, wherein the feed member is a signal contact for the antenna; and
(c) a ground member adjacent to the feed member, and electrically connected with the second radiation plane, and not coplanar to the second radiation plane.

7. The antenna of claim 6, further comprising a radiation bent member formed at one end extended from the first radiation plane.

8. The antenna of claim 7, wherein the radiation bent member is one-folded structure perpendicular to the first radiation plane.

9. The antenna of claim 7, wherein the radiation bent member is multi-folded structure.

10. The antenna of claim 6, wherein length of extension of the radiation body is about one quarter of a resonant wavelength of an application frequency.
